(19) United States
(12) Patent Application Publication
(10) Pub. No.: US 2005/0070655 A1
(43) Pub. Date: Mar. 31, 2005

(54) Composite compositions

(76) Inventors: Hugues Bertrand Van Den Bergen, Brussels (BE); Jeffrey Wang, Smyrna, GA (US); Giovanni Camino, Allessandria (IT)

Correspondence Address: WENDEROTH, LIND & PONACK, L.L.P., 2033 K STREET N. W., SUITE 800, WASHINGTON, DC, 20006-1021, US

(21) Appl. No.: 10/482,819

(22) PCT Filed: Jul. 3, 2002
(86) PCT No.: PCT/EP02/07371

(30) Foreign Application Priority Data
Jul. 4, 2001 (EP) 01116245.0

(51) Int. Cl. C08K 3/34

(52) U.S. Cl. 524/445

(57) ABSTRACT

There is described a composite composition comprising a layered mineral and at least one polymer precursor which is substantially miscible therewith; characterised in that: (i) the composition and/or polymer precursor are polymerisible by radiation to form a polymeric composition; and/or (ii) the polymer precursor comprises a polymer obtained and/or obtainable by polymerisation with radiation. Further described are composite compositions comprising a layered mineral and intercalated therein at least one polymer which is further polymerisable by radiation to form a polymeric network, such as a polymeric coating. Preferred minerals are nanoclays such a montmorillonite in which the counter cation comprises a radiation curable organo functional group covalently bonded thereto (e.g. an acrylate functional onium ion). Processes for making the composites are also described.

The present invention is directed toward radiation curable composite compositions comprising polymers with mineral materials. Such compositions are suitable for forming coatings. The coatings and/or compositions of the invention preferably comprise nano-sized minerals.

There is a continuing need for new materials exhibiting improved properties and which can be polymerised using radiation for example to form a coating as a thin or thick layer. Preferred methods to achieve radiation polymerisation comprise ultraviolet radiation and/or ionising radiation, such as gamma rays, X-rays or an electron beam.

Composite materials which comprise polymers with a mineral filler dispersed therein are well known. Recently interest has been shown in composites in which the minerals are nano-sized. It has already been proposed to incorporate layered minerals, such as clays or other inorganic fillers, into thermal cured polymer compositions to improve their mechanical and other properties.

Layered minerals typically comprise multi-layers of inorganic material (such as alumino-silicate platelets which typically exhibit an overall electric charge balanced by intercalated counter ions). If the individual layers (e.g. platelets) are completely separated to form dispersed mono-layers then the mineral is said to be exfoliated and exfoliated minerals are where the mineral layers are dispersed to the maximum extent.

A layered mineral refers to minerals which comprise a plurality of thin layers of mineral. The layers may be adjacent, mutually parallel layers (i.e. multi-layered) and/or fully dispersed in another medium. Layered material may exhibit order over short and/or long ranges. For example layers having long range order may comprise large homogenous areas of a particular polymorphic form (e.g. one or more amorphous, semi-crystalline, para-crystalline and/or crystalline form) in which adjacent layers are bound together. Layers having a short range order may comprise smaller dispersed structures such as individual or aggregate unbound layers in the form of for example particles (preferably which are non-spherically symmetric), platelets (e.g. flattened high aspect ratio particles), tactoids (ordered or disordered small aggregates of particles and/or platelets), aggregates thereof and/or mixtures thereof. Preferred layered materials used in the invention have short range order such as clays comprising platelets. Exfoliated minerals are layered minerals in which the layers are fully dispersed and thus are longer necessarily mutually parallel.

Intercalation denotes materials that are deposed in the space between adjacent mineral layers. As used herein an intercalated material also denotes material initially added between the material layers to swell the mineral and separate the layers but where the layers are now fully separated such that there are no longer parallel multi-layers or spaces between them and the composition is fully exfoliated. Thus exfoliation can be considered the upper limit of an intercalated material.

Nano-sized denotes that at least one linear dimension has a mean size of less than about one micron (1 μm=1×10⁻⁶ m), more preferably less than 100 nanometres (1 nm=1×10⁻⁹ m); most preferably from 0.1 nanometres to about 100 nanometres. Nano-sized materials exist with the nano-size in three dimensions (nano-particles), two dimensions (nano-tubes having a nano sized cross section, but indeterminate length) or one dimension (nano-layers having a nano-sized thickness, but indeterminate area). Preferred aspects of the present invention relate to minerals which comprise nano-layers. If nano-layer minerals are clays they may also be referred to herein as nanoclays.

A difficulty encountered in incorporating layered minerals in polymeric systems is their mutually immisciblity. Polymers such as the commonly used thermoplastic and thermoset polymers tend to have a hydrophobic character. Due to the charge on each layer the region between the two mineral layers has a more hydrophilic character. The most useful minerals have layers of nano-sized thickness and thus a small interlayer spacing. However intercalation polymer chains between the mineral layers is desired to achieve improved properties in the composite composition and/or also to swell the mineral and separate the layers to achieve complete exfoliation of the mineral within the polymer.

One method to alleviate the problem of immiscibility is to perform an ion exchange between ions in the sheets of the layered filler and ions of an organic character to make the filler more compatible with the polymeric matrix. However in conventional water or solvent based coatings, this method requires that the water or solvent must be evaporated which make the process slow and expensive because heat has to be applied. Also with solvent based coatings this method is environmentally unfriendly as it generates undesirable volatile organic compounds.

The following prior art references disclose compositions of layered inorganic filler with thermally cured polymers which is well known. None of the compositions so described are (co)polymerisable by radiation or comprise ingredients obtained from (co)polymerisable by radiation.

WO 97/00910 (=EP 0833863) (Exxon) describes nanocomposites formed by emulsion polymerisation where the nano-composite comprises a nanocomposite latex, a solid nanocomposite of a layered silicate mineral intercalated with an emulsion polymer and blends of the solid nanocomposite with other polymers. The latex contains a (co)polymer that is formed from a free radical polymerisable olefinic monomer(s). These polymers are neither obtained by radiation curing nor capable of being further curing by radiation.

WO 98/56598 (Michelin) describes a barrier coating mixture especially suitable for use on tyres the coating containing a carrier liquid in which Is dispersed (a) an elastomeric polymer preferably containing butyl groups; (b) a dispersed exfoliated layered filler having an aspect ratio greater than 25; and (c) at least one surfactant, wherein the solids content of the mixture is less than 30% and the ratio of polymer (a) to filler (b) is between 20:1 and 1:1. These elastomers are not radiation curable.

WO 00/34393 (Eastman Chemical) describes nanocomposites comprising a matrix polymer (which is defined as a thermoplastic or thermosetting polymer in which clay is dispersed to form a nanocomposite), a functionalised polymer or oligomer and a clay material. These materials are made using a melt compounding process and are not radiation curable.

WO 00/49082 (=U.S. Pat. No. 6,410,635) (PPG Industries) discloses curable coating compositions containing high aspect ratio clays. The coatings comprise a film-forming polymer containing reactive functional groups, a curing agent containing functional groups which are reactive with the functional groups of the polymer, and an exfoliated silicate material derived from a layered silicate (clay). The clay must be pre-exfoliated with a polymer which is compatible with both the film-forming polymer and the curing agent. The patent lists a large variety of film forming polymers but does not teach that curing might be achieved by radiation and the specific polymers exemplified and claimed are all thermally cured. In contrast in the present invention the clay comprises radiation curable polymers. The PPG document also teaches that the clay must first be exfoliated with a separate polymer from the film forming polymer in comparison to the invention herein where the clay is exfoliated with one polymer. There are significant disadvantages to the PPG method as very high shear is required to achieve clay exfoliation by polymer blending alone. Several steps are needed as the pre-exfoliated clay must first be collected by filtration and purified before the film forming polymer can be added. By contrast the present invention herein provides (in one embodiment) novel clays where the intercalating cations are oligomers ionically bound to the clay. The cationic oligomers can be cured by radiation in situ to exfoliate the clay within a single polymeric network. The oligomer intercalated clay of the invention herein can be produced in an one pot process as for example organo modified clay may be added to a conventional oligomer synthesis where the modified cation reacts to form a covalent bond with the oligomer.

WO 00/69957 (Edison Polymer) describes a method for preparing nanocomposite compositions from matrix polymers and plate like silicate or silicone fillers to form intercalates and/or exfoliated fillers. The composition comprises both intercalates and exfoliates of the fillers through the use of a small amount of a swelling agent which enters into the spaces between the platelets of the filler to improve the compatibility of the filler with most matrix polymers. The swelling agents used are small mobile molecules, oligomers, and/or polymers which have good compatibility toward the filler with or without cation exchange. Preferred polymers contain 1) at least 90% by weight of repeat units from mono-olefins or vinyl acetates, 2) at least 50% by weight of repeat units from conjugated C₄₋₈dienes or C₈₋₁₂vinyl aromatic monomers, or 3) a polyester or polyamide. These polymers are not radiation curable and a swelling agent is required to incorporate them into the nanocomposite due to their large size.

WO 01/04050 (NOvTNO) describes a method for preparing a composition for coating, wherein a layered, inorganic filler is subjected to an ion exchange with a modifier, which modifier comprises at least two ionic groups, which groups are separated from each other by at least four atoms, and wherein the modified filer, together with a polymer, is dispersed in a diluent. Although this document mentions in passing that the polymer may be radiation curable (page 1, line 24), in fact the ionic modifier may interfere with the curing efficiency of a radiation curable polymer (notwithstanding assertions by the applicant that these fillers do not adversely effect curing as this believed to refer to thermal curing only). No examples are given in which the compositions are subsequently radiation cured which indicates that the author of this document has not appreciated the problem with radiation curing. The present invention does not require modification of the mineral as described in WO 01/0450 and the compositions of the present invention are cured efficiently by radiation.

WO 01/36528 (GEC) describes resin compositions which comprise an intimate admixture of at least one ionomeric polyester and at least one organoclay and these compositions are not radiation curable.

EP 0267341 (ECC International Ltd) describes compositions of polyester or epoxy resin, with a readily dispersible organoclay, the clay being prepared by (a) suspending a smectite clay in water to form an aqueous suspension; (b) treating the aqueous suspension with a solution of an inorganic salt of a cation with valency ≧2 at a concentration sufficient to flocculate the smectite clay; (c) mixing the flocculated suspension with a quaternary ammonium compound comprising at least one C₁₀₋₂₄alkyl group; and (d) removing the water. These compositions are not radiation curable.

EP 0791556 (Nippon Paint) describes a water-dispersible organic clay complex in which a quaternary ammonium ion having both an oxypropylene unit and an oxyethylene unit is present in interlamellar space of an expansible phyllosilicate. The complex is used for controlling the rheology of a water-based coating agent. The final compositions are not co-polymerisable by radiation indeed the document suggests adding a UV absorber (page 8, lines 16 to 18) to improve weather resistance of the coating which teaches away from curing the coating by UV radiation.

EP 0909787 (Amcol International Corp.) describes nanocomposites where a phyllosilicate mineral is intercalated and exfoliated with N-alkenyl amide and an allylic monomers (and oligomer and/or polymers formed by polymerisation thereof) without the need for a swelling agent. The monomers described therein are absorbed in the mineral and intercalated due to co-ordination between functional groups on the monomer and the metal counter cations in the mineral. The N-alkenyl amide and allylic monomers are thermally cured (by free radical polymerisation) to form polymers and there is no teaching in this document that radiation curable monomers could be used. Although other monomers may also be added, these are used only to form copolymer intercalants with the N-alkenyl amide and allylic monomers.

EP 1033724 (Alcatel) describes coatings for power cables, the coatings comprising a layered inorganic mineral oxide in the form of a clay and an organic compound comprising a polymer, monomer or oligomer. These coatings are not formed by radiation polymerisation.

EP 1055706 (Rheox) describes compositions formed from intercalates between a organic chemical and a smectite clay (that has been ion-exchanged and reacted and intercalated with one or more quarternary ammonium compounds and an anionic material). This material is then further blended into a variety of polymers, whether polar or non-polar, to make nanocomposite compositions of improved dispersivity. Preferred polymers comprise polyolefins, copolymers thereof; copolymers of olefins and ethylene vinyl acetate, ethylene acid copolymers, ethylene-vinyl alcohols, ethylene-ethyl acrylates, and ethylene-methyl acrylates. These compositions are not radiation curable and in compositions of the present invention modification of the mineral is not necessary to achieve compatibility with the polymer precursors.

U.S. Pat. No. 5,849,830 (Cornell Research) describes nanocomposites manufactured by combining a host material (such as an organic solvent or a matrix polymer) with exfoliated intercalates formed by contacting a phyllosilicate with an intercalant adsorbed between adjacent phyllosilicate platelets. The intercalant is selected from (1) an N-alkenyl amide monomer and an allylic monomer; (2) an oligomer formed by co-polymerising an N-alkenyl amide monomer and an allylic monomer; (3) a polymer formed by co-polymerising an N-alkenyl amide monomer and an allylic monomer; and (4) mixtures thereof. Sufficient polymer is adsorbed between adjacent phyllosilicate platelets to expand the adjacent platelets to increase the spacing to at least about 10 Å (Angstrom units) so that the intercalate easily can be exfoliated to provide a carrier material for drugs and the like, or to provide a matrix polymer/platelet composite (nanocomposite) material the platelets being exfoliated from the intercalate. These nanocomposites are not radiation curable.

U.S. Pat. No. 5,554,670 (Amcol) describes a method of preparing layered silicate-epoxy nanocomposites by dispersing an organically modified smectite-type clay in an epoxy resin together with diglycidyl ether of bisphenol-A (DGEBA), and then curing in the presence of either nadic methyl anhydride (NMA), benzyldimethyl amine (BDMA), and/or boron trifluoride monoethylamine (BTFA) at 100° C. to 200° C. These compositions are not radiation curable.

U.S. Pat. No. 6,156,835 (Dow) describes a polymer composite comprising a hydroxy-phenoxyether or polyester polymer matrix having dispersed therein layers of an inorganic material derived from a multi-layered inorganic material having organophilic properties. The dispersion of the multi-layered inorganic material in the polymer matrix is such that an increase in the average interlayer spacing of the layered inorganic material occurs to a significant extent resulting in the formation of a nanocomposite. The polymers may be derived from a diglycidyl ether or ester or an epihalohydrin and a di-nucleophile such as a di-carboxylic acid, a di-functional amine, a bisphenol or a sulfonamide. Preferably the organophilic inorganic material clay is a mineral modified with organic ammonium compounds. These nanocomposites are not radiation curable.

DE 19821477 (BASF) describes thermoplastic nanocomposites useful for producing film, fibre, moulded articles or coatings, the nanocomposites containing (A) 50% to 99.99% by weight of a polymer of carbon monoxide and an olefinically unsaturated compound; (B) 0.01% to 50% by weight of a delaminated layer silicate; (C) 0 to 40% by weight of a fibrous filler; (D) 0 to 30% by weight of other additives; and (E) 0 to 30% by weight an elastomeric rubber polymer. These nanocomposites are not radiation curable.

“Organophilic clays: inventing advantages” by Ken Schoenfeld was published in “American Ink Maker”, January 1995, Vol. 73, No. 1. The paper describes in general terms the properties of montmorillonite clays and gives the advantages of incorporating such clays in ink formulations.

The above describes prior art describe methods for uniting layered fillers and polymeric matrices which are bulk polymeric materials and coatings which are thermal cured. The particular difficulties involved with making radiation curable coatings and polymers compatible with layered minerals have not been addressed.

The following references disclose compositions which contain simple mixtures of UV curable polymers with layered minerals.

JP 01-266533-A (Sekisui Chem.) (=Derwent abstract XP 002184451) describes a layered mineral impregnated with a thermal hardening agent between the layers. The compositions which also comprise radiation curable monomers are used to make solder resists for printed circuits. However such compositions do not contain, and teach away from, minerals with intercalated radiation curable polymers. JP 07-090229-A (Sekisui Chem.) (=Derwent abstract XP 002184452) describes a low viscosity UV curable mixture to form substrates for pressure sensitive adhesive tapes. The mixture comprises co-monomers of (meth)acrylate, polar monomer and unsaturated monomer; a photo-initiator; and a hydrophobic modified clay. There is no teaching in this document that the clay is intercalated with polymer or exfoliated or how this may be achieved. It is likely that the clay is simply dispersed as agglomerates in the UV cured copolymer especially if the clay is hydrophobic and the copolymer has polar groups.

CAS 130:12571 g; Supramol. Sci. (1998), (3-4), pp 303-308; Dept. of Cryst. Mat. Sci., Grad. School of Eng., Nagoya Univ, Chikusa, Japan; describes a nanoclay with cationic layers in which a 4-vinylbenozate or 4-benzoyl benzoate anions are intercalated therein to form the counter ion. These anions are then UV irradiated to cyclodimerise and then undergo radical polymerisation to form an intercalated non cross-linked linear polymer. These counter ions are small and non polymeric and so are directly compatible with the clay. This reference does not teach how much larger oligomers could be intercalated into a clay to form radiation curable mineral composites suitable for forming coatings comprising polymeric networks.

Thus these prior art references do not describe methods for preparing radiation curable polymer networks in which the polymers are intercalated in the layered mineral and/or the mineral is fully exfoliated. The particular difficulties involved with making radiation curable coatings and polymers compatible with layered minerals have not been addressed or adequately resolved by the prior art.

An abstract entitled “Novel UV-curable nano-composite materials” by Mr. K. Zahouily, University of Mulhouse was published in the June 2001 No. 2 Special Edition of RadTech News Europe, 6—New & Innovative Applications Sessions—page 25 which foreshadowed a RadTech 2002 conference in Basel held 8-10 Oct. 2002 (see below). The abstract read:
“UV curable composites are increasingly used in various industrial applications, because of their superior performance regarding processing and product properties. Composite materials that exhibit a change in composition and structure over nanometer length scale have been shown to afford remarkable property enhancement relative to micrometer-scaled composites. Such nanocomposites materials have been synthesized within seconds at ambient temperature by UV-irradiation of chemically modified clay powder impregnated with an acrylate resin. The required exfoliation of the nanometer-thick platelets was demonstrated by X-ray diffraction (XRD). Photoset nanocomposites may offer enhanced physical properties, in particular increased heat resistance, strength, stiffness and barrier properties. Because particle sizes are inferior to the wavelength visible light, they do not change optical properties such as transparency.”
This abstract does not provide sufficient practical information to enable such nanocomposites to be prepared nor does it indicate how the clay was impregnated with acrylate resin to achieve the asserted exfoliation.

The following papers were published during the priority year of the present application. They are included herein for completeness only as they do not comprise part of the prior art which may be cited against those aspects of the present invention which have a valid claim to priority.

“A novel class of hybrid organic/clay UV-curable nano-composite material” by K. Zahouily et al in Technical Conference Proceedings for Rad Tech 2002 conference pp 309-320 (held in Basel, Switzerland, 8-10 Oct. 2001) was published shortly after the paper had been orally presented at the conference (the presentation had been foreshadowed in the abstract described above). A similar paper entitled Novel UV-curable nano-composite materials by the same authors was published May 2002. These papers describe bentonite and montmorillonite clays which have been exfoliated by a UV curable polymerisable formulation comprising acrylic monomer (25% by weight of hexane diol acrylate (HDDA) from UCB) and an aliphatic polyurethane acrylate (65% by weight of Ebecryl-284 or Ebecryl-8402 from UCB) with a mixture of the two photo-initiators phenyl bis(2,4,6-trimethyl benzoyl) phosphine oxide and 2-hydroxy-2-methyl-1-phenyl-1-propanone (respectively 1% and 2% by weight of Iragcure 819 and Darocur 1173 both from Ciba Speciality Chemicals). The clay metal counter cations have been ion exchanged by either an alkyl ammonium salt (hexadecyltrimethylammonium chloride from Aldrich) or an acrylated amine (CN-550 from Cray Valley) to make the clay compatible with and/or incorporate acrylate monomer. This approach is limited as the exchanged cations are of low molecular weight.

“A study on the preparation of polymer/montmorillonite nano-composite materials by photo-polymerization” by Wang Huimin et al in Polym. Int. 51:7-11 (2001) was published online on 7 Dec. 2001. The paper describes a composite material formed by intercalation of an octadecylamino modified hydrophobic montmorillonite clay with two alternative radiation curable polymerisable systems with different curing mechanisms. The first system was methyl methacrylate monomer (MMA) with benzoin diethyl ether as the photo-initiator. The second system was a prepolymer of m-cresol resin and N,N-hexa(methoxymethyl)-2,4,6-triamino-1,3,5-triazine (HMMM) with a photo-acid generating initiating system of 2-phenyl-4,6-bis(trichloromethyl)-1,3,5-triazine (TCTA) with bis-5N,N-deimethylbenxilidein)acetone (DMBA) to sensitise for electron donors. The data from this paper indicates that the clay was intercalated with polymer (where some layered clay structure remains) rather than fully exfoliated (where each clay layer is fully separated so that any crystalline structure of the clay is destroyed).

It is an object of the invention to provide a composition and/or coating which solves some or all the problems with prior art mineral-polymer composite compositions.

Broadly one aspect of the invention comprises a composite composition comprising a layered mineral and at least one polymer precursor which is substantially miscible therewith; characterised in that:
(i) the polymer precursor is polymerisible by radiation to form a polymeric composition; and/or
(ii) the polymer precursor comprises a polymer obtained and/or obtainable by polymerisation with radiation.

Preferably the polymer precursor is both polymerisible by radiation and the polymer precursor is a polymer obtainable and/or obtained by radiation polymerisation.

Preferably the layered mineral is intercalated (preferably exfoliated) with the polymer precursor.

As used herein the term “layer mineral” encompasses minerals where a layer structure remains in whole or in part (e.g. where material is intercalated between layers of clay throughout the mineral or in regions thereof) and also encompasses minerals comprising compositions and/or regions derived from layer minerals but where the layers are fully separated by other material (e.g. where the mineral can be said to be fully exfoliated, again throughout the mineral or in regions thereof). Broadly in accordance with another aspect of the invention there is provided a composite composition comprising a layered mineral and intercalated therein at least one polymer which is further polymerisable by radiation to form a polymeric network, such as a polymeric coating.

A yet another aspect of the invention provides a composite composition obtained and/or obtainable by radiation polymerisation of a composite composition as described herein.

The coatings and/or composites of the invention may preferably impart and/or exhibit resistance to attack such as an improved resistance to mechanical and/or chemical attack. For example they may be impart improved flame retardancy, heat resistance, abrasion resistance, scratch resistance, barrier properties, outdoor resistance, mechanical properties and/or combinations of any of these properties.

Preferred minerals comprise nano-layers and/or clays, more preferably comprise nanoclays.

Preferably the mineral is present in the composite in an amount from about 1% to about 5%, by total weight of the composition. Conveniently the mineral is present in the composite in an amount from about 1% to about 15%, conveniently from about 2% to about 10%, more conveniently from about 3% to about 5% by total weight of the composition.

The compatibility of the radiation cured polymer (oligomer) with the layered mineral to achieve intercalation of the mineral may be achieved in several ways.

One method is to ion exchange the counter ion in the mineral with an ion comprising larger more hydrophobic groups thereon. The hydrophobic radiation curable oligomer may then be intercalated within the mineral layers by adsorption within the more compatible (more hydrophobic) inter layer spaces as a simple physical blend with the counter ion.

Another method is to also use an (ion exchanged) counter ion which is more hydrophobic but also comprises reactive functional groups thereon which will react with the oligomer to form a radiation curable oligomeric counter ion. After radiation curing, the polymers are bound to the mineral layer by ionic charge. The same effect can also be achieved by direct addition of a radiation curable polymeric counter ion which is intercalated in the mineral provided that such a counter ion can readily ion exchange with the mineral and is compatible therewith.

An aspect of the present invention is novel nanoclays intercalated with radiation curable oligomeric cations (such as cations with a mw above 300). There are two alternative routes preferred for intercalating oligomeric cations. Both have the advantage that they can be performed as a one pot process. In the first method a conventional organo modified nanoclay with a functionalised cation (e.g. an alkyl ammonium ion functionalised with suitable reactive groups such as hydroxy, epoxy or carboxy) can be added to the reagents used to synthesise conventional radiation curable oligomers. The functional group on the cation (such as hydroxy, epoxy or carboxy) can act as the nucleophile in a Michael addition to an activated double bond (e.g. (meth)acrylate) to produce in situ a UV-curable oligomeric cation which is ionically bound to and intercalates the clay In the second method a conventional radiation curable oligomer (such as amino acrylate) may be prepared and then protonated in situ (e.g. with HCl) or alkyl ated in situ (e.g. with MeI) to form a salt which can ion exchange cation in the presence of a natural nanoclay (e.g. sodium montmorillonite) to form a clay intercalated with UV curable oligomeric cations.

In a still further method the mineral layers are chemically modified directly by covalent bonded organo groups thereon (e.g. through the silane bonds to silicates) which increase the compatibility of the mineral with the oligomer. Optionally the layers may be modified to remove or substantially reduce their net electric charge to reduce the number of inter layer counter ions, which also improves hydrophobicity. As the first method, the oligomer is absorbed with the mineral layers as a simple physical blend.

The yet other method uses a mineral in which the layers are chemically modified by covalent bonded organo groups thereon, where the groups are reactive with the oligomer to form a radiation curable oligomeric chain covalently attached to the layer in the inter layer space. After radiation curing, the polymers are bound to a mineral layer by a covalent charge.

It will be appreciated that these methods can be combined for example both the mineral layer and the counter ion can be modified to improve compatibility and/or reactivity with the oligomer. Although nano-layered materials are preferred it is possible that layered minerals could be prepared which are larger than nano-sized with improved properties especially if the modifying agent is novel.

Organo modified minerals and/or counter ions can be made inexpensively such that the swollen and/or modified minerals may be used with conventional radiation curable polymers which need no other treatment to allow intercalation (including exfoliation) between mineral layers. The present invention allows layered minerals and radiation curable polymers to be homogeneously dispersed to form improved composites. The composites may then be radiation cured to form improved coatings.

A nano-composite material is used herein to refer to a material which comprises a plurality of phases at least one of which is nano-sized, for example a mixture of a nano-layer mineral (e.g. nano-clay) intercalated with a radiation curable polymer as described herein.

Advantageously the layered mineral comprises a natural or synthetic mineral, more advantageously the mineral comprises minerals based on layered silicates (such as layered phyllosilicate) and for example which comprise magnesium and/or aluminum silicate layers each having a thickness usefully from about 7 Å about 12 Å. However any natural or synthetic layered mineral (preferably which can be intercalated) may be used in the present invention.

Thus layered mineral used in the present invention may comprise a clay such as any of the following which are suitable:
kaolins, such as kaolinite, dickite, nacrite; halloysite (7 Å) and/or halloysite (10 Å);
serpentines, such as lizardite, chrysotile, antigorite, carlosturanite, forsterite, asbestos, amestite, cronstedite, chamosite, berthierine, and/or garnierite;
talcs, pyrophyllites, and/or ferropyrophyllites;
smectites and/or montmorillonites; such as bentonite; beidellite, nontronite, hectrorite, fluorohectorite, saponite, sauconite; volkhonskoite, medmontite, pimelite, stevensite and/or stephanite;
illites and/or micas such as muscovite, bravaisite, degraded mica, hydromica, hydromuscovite, hydrous illite, hydrous mica, K-mica, micaecous, clay and/or sericite;
glauconites such as calcdonia;
chlorites and/or vermiculites such as clinochlore, chamosite, nimite, baileychlore, donbassite, cookite, sudoite, franklinfurnaceite and/or corrensite;
palygorskites and/or sepiolites such as attapulgite;
mixed layer minerals which may comprise two three or more mineral components in random and/or regular order, examples of such mixed layer minerals comprising pillared clays, illite-montmorillonite, smectite-illite, illite-chlorite-smectite and/or illite-smectite-vermiculite;
amorphous clays such as allophane and/or imogolite, and/or
high alumina clays such as diaspore, boehmite, gibbsite, cliachite, bauxite, bauxitic kaolin and/or bauxitic clays;
other clays such as fire clay, flint clay, nodular clay, burley clay, abrasive clay, loess and/or abobe and/or any suitable mixtures and combinations thereof.

Preferred clays for use in the present Invention comprise kaolins, smectites chlorites, vermiculites, combinations and/or mixtures thereof; more preferably are selected from one or more: montmorillonite, bentonite, saponite, hectorite, fluorohectorite, beidellite, nontronite, vermiculite, halloysite, stevensite and/or stephanite; most preferably montmorillonite for example bentonite.

The layered mineral used in the invention can be both cationic and anionic in nature. In principle, any anionic or cationic mineral obtained synthetically or from a natural source can be used. A suitable clay type preferably has a cation exchange capacity of 30 to 250 milli-equivalents per 100 grams. Preferably, a clay is used having a cation exchange capacity of from 50 to 200 milli-equivalents per 100 grams.

Another layered mineral that can be used in the invention is a layered double hydroxide (LDH). This material is a so-called anionic clay, consisting of small crystalline sheets of dimensions of a few nanometres, between which anions are located. By these anions are meant anions other than hydroxyl groups. A layered double hydroxide can be both natural and synthetic in nature. Methods for preparing synthetic LDH are described in U.S. Pat. No. 3,539,306 and U.S. Pat. No. 3,650,704 the contents of which are hereby incorporated by reference. Preferably the LDH has a large contact surface and an ion exchange capacity of 0.5 to 6 milli-equivalents per gram. More preferred LDHs are hydrotalcite or hydrotalcite-like materials which can be easily prepared synthetically, while the desired properties can be eminently controlled.

Preferably the radiation curable polymer has a number average molecular weight (Mₙ) of less than about 10,000 daltons, more preferably from about 300 to about 5,000 daltons most preferably from about 500 to less than about 3,000 daltons.

The radiation curable polymer may be an oligomer and may itself be obtained and/or obtainable by radiation polymerisation. The radiation curable polymer may comprise any that are well known as conventional in radiation curable compositions, and for example may comprise at least one group selected from an activated unsaturated moiety and/or a (thio)ether moiety.

Because the preferred oligomers are much smaller than the bulk polymers used in the prior art thermally cured mineral and polymer mixtures, there is less of an issue in terms of compatibility between the mineral layers and oligomers.

Optionally the radiation curable polymer is not obtained by emulsion polymerisation method, is not a emulsion polymer latex, is not an ionomer and/or is not further polymerisable by an emulsion polymerisation method.

Preferably the polymer comprises at least one oligomer having radiation polymerisable double bonds (optionally by well known processes such as free radical and/or cationic mechanisms) such as (meth)acrylated oligomers comprising for example ester, urethane, ether, silicon, halogen and/or phosphorus groups.

More preferred oligomers comprise: copolymers with (meth)acrylate group(s) and one or more (poly)ol, (poly)urethane; (poly)ester; (poly)ether, (poly)epoxy, (poly)amino, (poly)silicone, poly(meth)acrylate, phosphorus-containing moeties, silicon-containing moieties halogen-containing moieties; organic-inorganic hybrid materials; and/or combinations thereof any of which are radiation curable (preferably radical polymerisable).

Organic-inorganic hybrid materials are understood to be materials which are built up from a combination of polymeric organic and inorganic/ceramic components which are mutually chemically bonded on a molecular level, which may further contain inorganic nano-particles dispersed therein. The composition of the present invention may also further blended with one or more further polymer precursors (which may be the same or different to those intercalated in the mineral layer) to form a blend of polymer precursor and the composition. Preferably the amount of the composition in the blend is from about 0.1% to about 70% by weight of the total blend.

Preferred compositions of the invention are substantially free of organic solvents as no solvents are used to prepare the compositions (other than optionally water) or in the curing process which preferably used UV or EB radiation.

These coating compositions, beside having improved properties have several other advantages for example the energy required to cure is low as no organic solvent have to be evaporated, the cure speed is high and they are environmentally friendly because they have a very low emission of volatile organic compounds (also denoted herein by the term “VOC”).

Compositions of the invention may be applied to an article and cured in situ by radiation (e.g. UV radiation in presence of a photo-initiator or by electron beam radiation) to form a coating thereon having improved properties.

Optionally the layered mineral is intercalated with a counter ion which is compatible with the radiation cured polymer. Preferred minerals comprise anionic mineral layers (e.g. alumino-silicate) intercalated with hydrophobic counter cations.

Optionally the counter ion comprises at least one hydrophobic group such as a C_{<12}hydrocarbo group.

Optionally the counter ion comprise at least one group capable of reacting with the radiation curable polymer to form a covalent bond thereto such that the reaction product is a radiation curable polymeric counter ion.

Preferred counter cations comprise optionally substituted organo onium cations, more preferably those represented by the formulae
⁺(MR¹R²R³R⁴); and/or ⁺(PyR⁴); where
M is nitrogen or phosphorus, most preferably is nitrogen
R¹, R², R³, and R⁴ independently denote hydrogen or an optionally substituted hydrocarbo group, preferably H or hydrocarbyl optionally substituted by one or more hydroxy or carboxy group(s), more preferably H or alkyl, aryl or allyl group, most preferably at least one of which is other than hydrogen and is substituted by a hydroxy or carboxy group; and
Py denotes a pyridinium or an alkyl substituted pyridinium group.

Conveniently the onium cations above, more preferably at least one of R¹, R², R³ and R⁴ comprise at least one activated double bond as described herein.

Conveniently the counter cation(s) may be represented by one or more of the following formulae 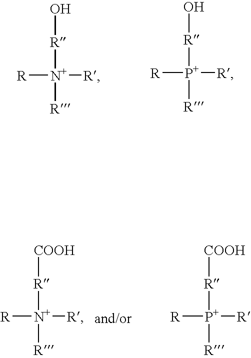
where R, R′ and R″ independently represent H or any suitable optionally substituted organo group such as optionally substituted C₁₋₃₀hydrocarbyl, for example C₁₋₂₀alkyl; and R′″ independently represents any suitable optionally substituted divalent organo linking group such as optionally substituted C₁₋₃₀hydrocarbylene, for example C₁₋₂₀alkylene. Conveniently at least one of R, R′, R″ and R′″ comprise at least one activated double bond as described herein.

Examples of specific clays which may be used in the present invention may include unmodified counter ions and/or counter ions which have been modified with organic groups for example any of the following clays and/or mixtures thereof, where the cations listed are also most preferred for other clays:
those montmorillonite clays available commercially from Süd Chemie under the following trade names:
Nanofil 757, cation is Na+, 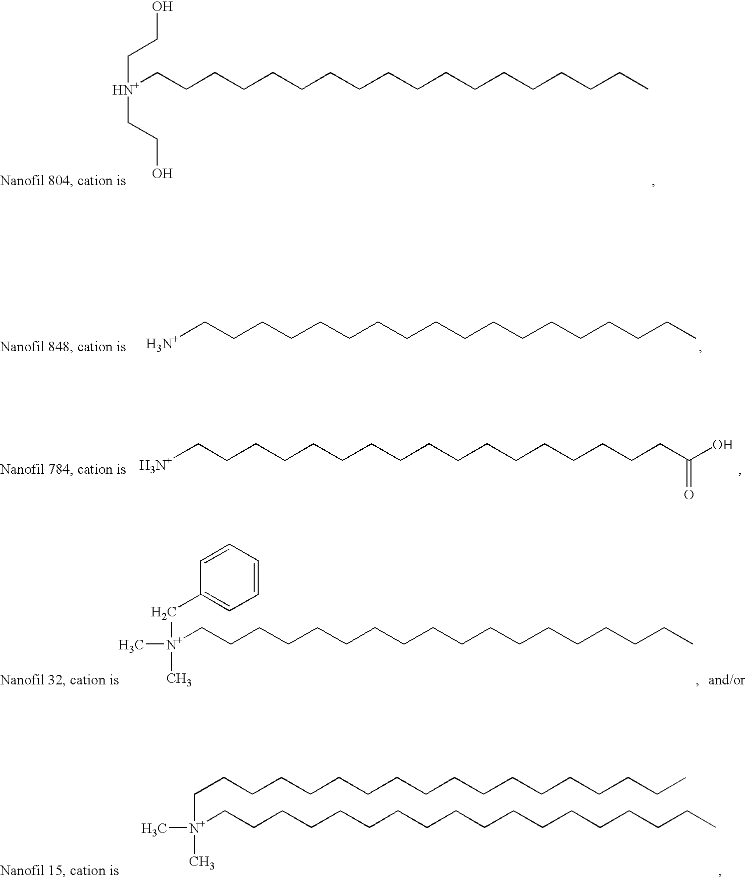
   those bentonite clays available commercially from Southern Clay under the following trade names:

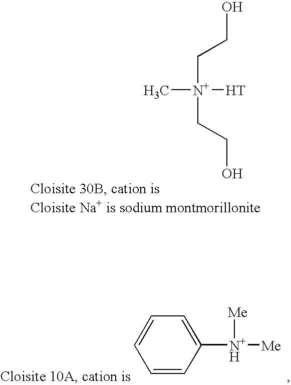

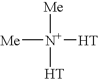

Cloisite 15A & Cloisite 20A each with the cation differing in the cationic exchange capacity of the clay, 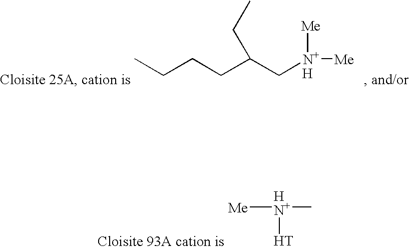
where HT denotes a hydrogenated tallow residue comprising linear alkyl groups in the approximate proportion ˜65% C₁₈alkyl ˜30% C₁₆alkyl and ˜5% C₁₄alkyl; and/or
those mica clays available from Unicoop Jap under the following trade names:
   Somasif ME 100 is an unmodified fluoromica, and/or
   Somasif MAE is tallow ammonium salt modified fluoromica.

Preferred reactive groups on the counter ion comprise any group which is capable of reacting with the radiation curable polymers described herein to form a covalent bond thereto without significantly effecting the polymers ability to be polymerised by radiation. The counter ion may advantageously comprise as a reactive group an olefinically unsaturated bond, preferably a (meth)acrylate group, which may be in the terminal position.

Embodiments of suitable types of reaction are illustrated generally below where R, R′, R″ and R′″ independently represent those groups given above for the onium cations. Most preferably the final reaction product comprises counter cation(s) which are polymerisable by radiation (such as UV and/or electron beam).

As used herein an arrow attached to an atom in a formula denotes the position of a covalent bond between the radical illustrated in the formula and another moiety (such as the remaining counter cation).

One reaction which can be used to modify hydroxy functional cations comprises the step of reacting the hydroxy group with (optionally substituted) succinic or maleic anhydrides (such as 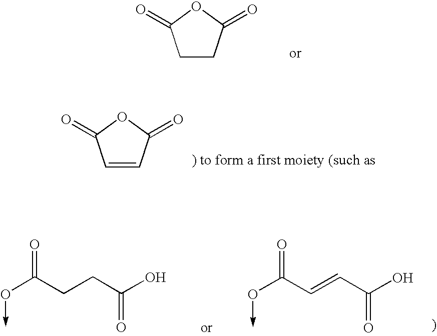
which is covalently attached to the cation at the position of the original hydroxy group. The carboxy group of the first moiety may then under go further reactions as described later to form a second moiety. An example of this reaction is shown schematically:

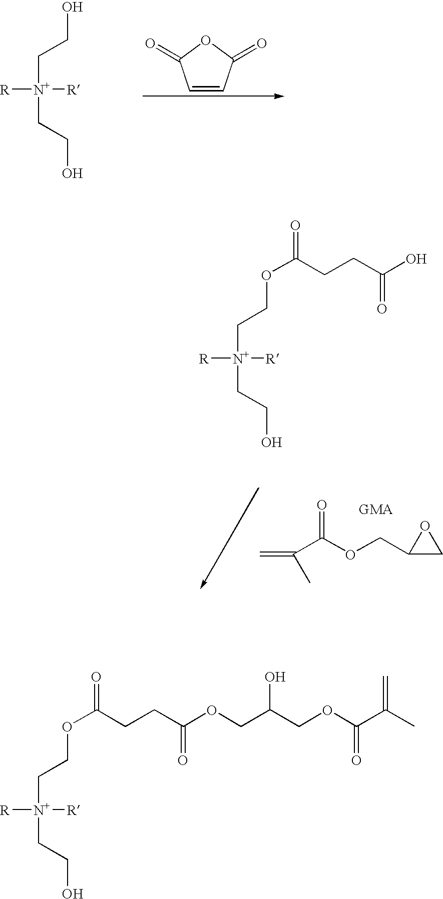

Another reaction which can be used to modify hydroxy functional cations comprises the step of reacting the hydroxy group with an (optionally substituted) isocyanate (such as R—NCO) to form a moiety (such as 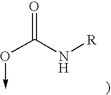
which is covalently attached to the cation at the position of the original hydroxy group.

An example of this reaction is shown schematically:

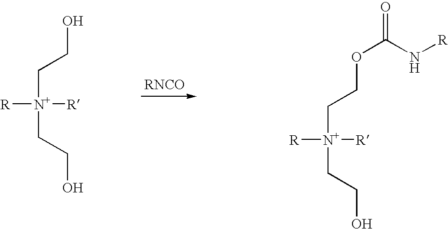

A further reaction which can be used to modify hydroxy functional cations comprises the step of reacting the hydroxy group with an (optionally substituted) methacrylate isocyanate (such as 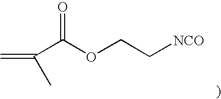
to form a moiety (such as 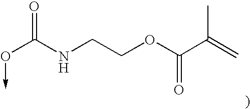
which is covalently attached to the cation at the position of the original hydroxy group.

An example of this reaction is shown schematically:

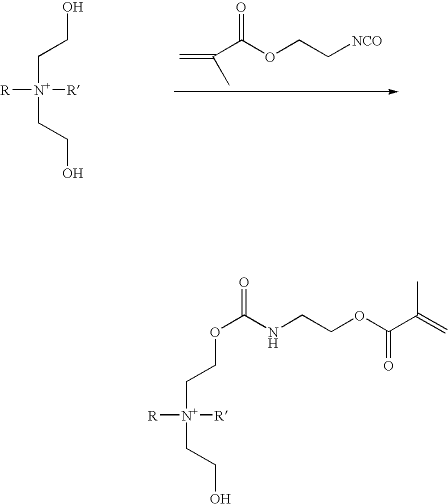

A still further reaction which can be used to modify hydroxy functional cations comprises the step of reacting the hydroxy group with an (optionally substituted) (meth)acrylate (such as 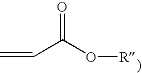
to form a moiety (such as 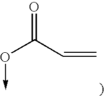
which is covalently attached to the cation at the position of the original hydroxy group. It is preferred that R″ is H or alkyl.

An example of this reaction is shown schematically:

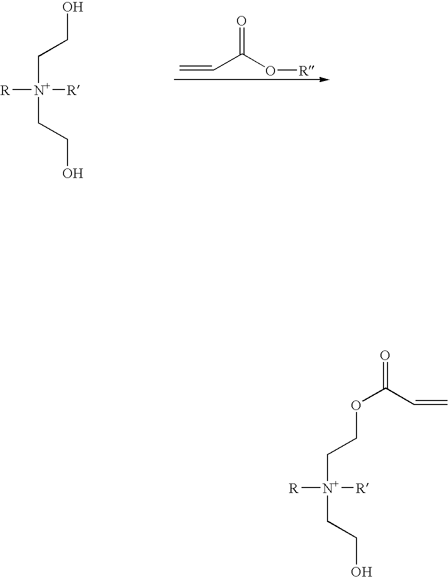

A yet further reaction which can be used to modify hydroxy functional cations comprises the step of reacting the hydroxy group with an (optionally substituted) oxirane (i.e. 3 or 4 membered oxy containing ring, such as 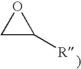
to form by ring opening one or more alkoxy groups covalently attached to the cation at the position of the original hydroxy group. It is preferred that R″ is H or alkyl in which case the alkoxy group is ethoxy or n-propoxy respectively.

An example of this reaction is shown schematically:

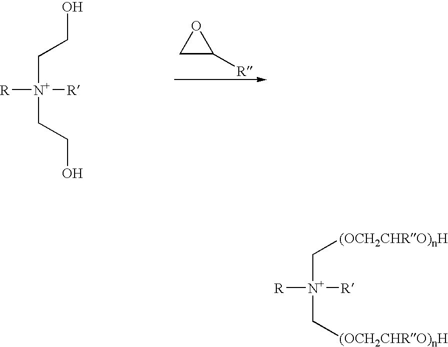

A yet still further reaction which can be used to modify hydroxy functional cations comprises the step of reacting the hydroxy group with an (optionally substituted) (poly)ester such as a cyclic polyester for example ε-(epilson)-caprolactones (e.g. 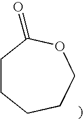
to form an ester moiety (such as 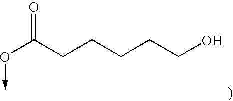
which is covalently attached to the cation at the position of the original hydroxy group.

An example of this reaction is shown schematically:

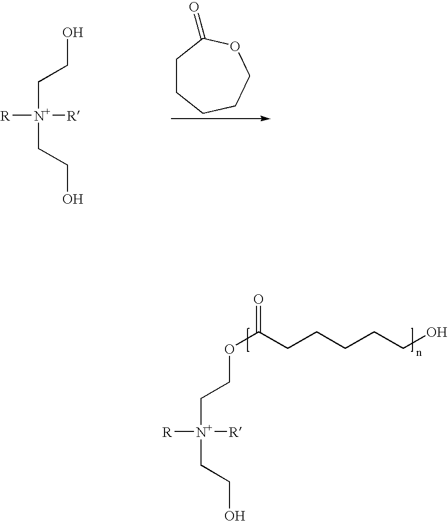

A reaction which can be used to modify carboxy functional cations (including those initially generated from hydroxy functional cations as described above) comprises the step of reacting the carboxy group with an (optionally substituted) epoxy (meth)acrylate ((such as glycidyl methacrylate 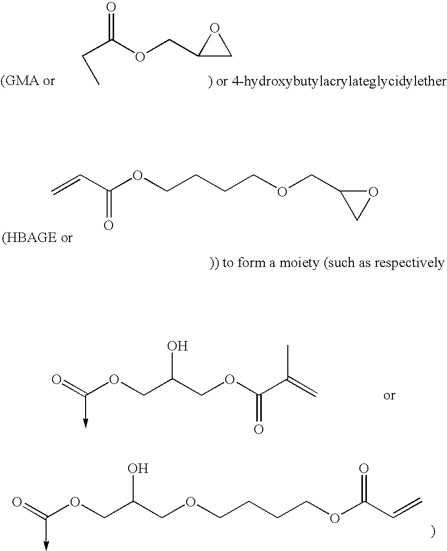
which is covalently attached to the cation at the position of the original carboxy group.

Examples of these reactions are shown schematically:

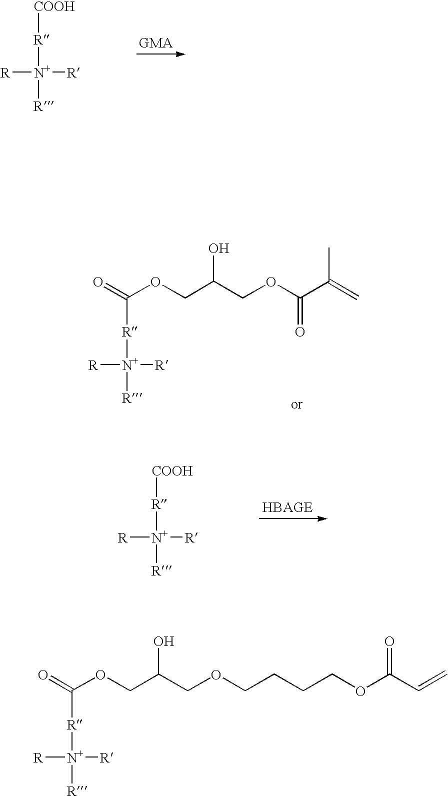

Alternatively the counter ion may itself already be polymerisable by radiation (i.e. can also form the polymer component) without further modification or reaction.

For example it may be possible to make amino compounds analogous to the ammonium cations described above (by analogous methods to those described above or by any other suitable methods). Such UV curable amino acrylates may then be protonated (e.g. with hydrochloric acid) or alkylated (e.g. methyl iodide) to form a quaternary ammonium salt which can then be ion exchanged with a natural nanoclay (such as sodium montmorillonite) to give a nanoclay intercalated with oligomeric cation. Suitable amino acrylates include those available commercially from UCB Chemicals under the trade names P115, Eb 81, Eb 83, Eb 84 and others. This provides an alternative to the cation functionalisation route for preparing nanoclays with oligomeric cations.

Optionally the layered mineral may be modified with an agent to make the mineral more organophilic and thus improve its compatibility with the polymer. For example the mineral layer may be modified by moieties which covalently bind to the silicate groups and comprise hydrophobic groups. The mineral may also be modified by attaching thereon the same groups which are capable of covalently bonding to the radiation curable polymer such that after reacting with the polymer the mineral layer has attached thereto a radiation curable polymer. Preferred reactive groups are as described above.

Thus it is preferred that before mixing with the polymer the layered mineral used herein is first subjected to an ion exchange by addition of a swelling agent and/or the mineral is organo modified using a modifying agent.

The swelling agent comprises at least one counter ion as described herein. If the swelling agent comprises an onium salt, preferred anions are selected from halide, hydroxy, nitrate, and/or sulphate. Preferred swelling agents comprise quaternised and/or protonated radiation curable amino acrylate oligomers which are both the counter ion and the radiation curable polymer.

The modifying agent comprises at least one group as described herein which is hydrophobic and/or is capable of reacting with the radiation curable polymer as described above.

As the preferred polymers intercalated herein are small species of, a low molecular weight (e.g. compared to the more hydrophobic polymers used to prepare prior art thermally cured nanocomposites) the use of both a modified counter ion and/or modified mineral layer Is not essential to incorporate these polymers in the layered mineral to form the radiation curable composites of the invention and only one of these treatments may be necessary.

The modifying and/or swelling agents may further comprise dye to give the composition a desired colour. Suitable are cationic and anionic dyes and dyes which can be brought into cationic or anionic form by protonating or deprotonating. These are, for instance, dyes with N⁺, P⁺, S⁺ functionalities and/or derivatives thereof. Additionally preferred are dyes with anionic functionalities such as RCO₂⁻, RP(O)O₂²⁻ and RSO₃⁻, wherein R denotes an alkyl, aryl or alkylaryl group. Also preferred are dyes where the charge is divided over different functional groups. Examples of suitable dyes are mentioned inter alia in Ullmanns Encyklopadie der technische Chemie, band 11, Verlag Chemie, Weinheim, 1976 under “Farbstoffen”.

Throughout this specification, the term “activated unsaturated moiety” “is used to denote an species comprising at least one unsaturated carbon to carbon double bond in chemical proximity to at least one activating moiety. Preferably the activating moiety comprises any group which activates an ethylenically unsaturated double bond for addition thereon by a suitable electrophillic group.

Conveniently the activating moiety comprises oxy, thio, (optionally organo substituted)amino, thiocarbonyl and/or carbonyl groups (the latter two groups optionally substituted by thio, oxy or (optionally organo substituted) amino). More convenient activating moieties are (thio)ether, (thio)ester and/or (thio)amide moiet(ies). Most convenient “activated unsaturated moieties” comprise an “unsaturated ester moiety” which denotes an organo species comprising one or more “hydrocarbylidenyl(thio)carbonyl(thio)oxy” and/or one or more “hydrocarbylidenyl(thio)-carbonyl(organo)amino” groups and/or analogous and/or derived moieties for example moieties comprising (meth)acrylate functionalities and/or derivatives thereof. “Unsaturated ester moieties” may optionally comprise optionally substituted generic α,β-unsaturated acids, esters and/or other derivatives thereof including thio derivatives and analogs thereof.

Preferred activated unsaturated moieties are those represented by Formula 1′. 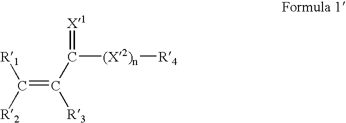
where
n′ is 0 or 1,
X′¹ is oxy or, thio
X′² is oxy, thio or NR′₅ (where R′₁₅ represents H or optionally substituted organo),
R′₁, R′₂, R′₃ and R′₄ each independently represent H, optionally substituents and/or optionally substituted organo groups; and
all suitable isomers thereof, combinations thereof on the same species and/or mixtures thereof. More preferably one of the optionally substituents comprises amino or alkylamino.

Formula 1′ may represent a cation suitable for use in the present invention in which case one of the groups therein comprises a positive charge (such as a positively charged nitrogen or phosphorus atom) for example a amino group may be protonated (e.g. with hydrochloric acid) or alkylated (e.g. with methyl iodide) to form a quaternary ammonium salt.

Alternatively Formula 1′ may represent a mono or multi-valent radical attached to a suitable cation (as described herein) in which case one of the groups described in Formula 1′ represent its corresponding mono or multivalent radical (i.e. with one of more free valencies e.g. by having one or more hydrogen atoms abstracted therefrom).

It will be appreciated that the terms “activated unsaturated moiety”; “unsaturated ester moiety” and/or Formula 1′ herein may represent a discrete chemical species (such as a compound, ion, free radical, oligomer and/or polymer) and/or any part(s) thereof. Thus Formula 1, may also represent multivalent (preferably divalent) radicals. Thus the options given herein for n′, X′¹, X′², R′₁, R′₂, R′₃, R′₄ and R′₅ also encompass corresponding bi or multivalent radicals as appropriate.

More preferred moieties of Formula 1′ (including isomers and mixtures thereof) are those where n′ is 1; X′¹ is 0; X′² is O, S or NR′₅;
R′₁, R′₂, R′₃, and ′R₄ are independently selected from: H, optional substituents and optionally substituted C₁₋₁₀hydrocarbo, and
where present R′₅ is selected from H and optionally substituted C₁₋₁₀hydrocarbo.

Most preferably n′ is 1, X′¹ is 0; X′₂ is O or S and R′₁, R′₂, R′₃ and R′₄ are independently H, hydroxy and/or optionally substituted C₁₋₄hydrocarbyl.

For example n′ is 1, X′¹ and X′₂ are both 0; and R′₁R′₂, R′₃ and R′₄ are independently H, OH, and/or C₁₋₄alkyl.

For moieties of Formula 1‘where n’ is 1 and X′¹ and X′² are both 0 then:
when one of (R′₁ and R′₂) is H and also R′₃ is H, Formula 1′ represents an acrylate moiety, which includes acrylates (when both R′₁ and R′₂ are H) and derivatives thereof (when either R′₁ or R′₂ is not H). Similarly when one of (R′₁ and R′₂) is H and also R′₃ is CH₃, Formula 1′ represents an methacrylate moiety, which includes methacrylates (when both R′₁ and R′₂ are H) and derivatives thereof (when either R′₁ or R′₂ is not H). Acrylate and/or methacrylate moieties of Formula 1′ are particularly preferred.

Conveniently moieties of Formula 1‘are those where n’ is 1; X′¹ and X′² are both 0; R′₁ and R′₂ are independently H, methyl or OH, and R′₃ is H or CH₃.

More conveniently moieties of Formula 1‘are those where n’ is 1; X′¹ and X′² are both 0; R′₁ is OH, R′₂ is CH₃, and R′₃ is H, and/or tautomer(s) thereof (for example of an acetoacetoxy functional species).

Most convenient unsaturated ester moieties are selected from: —OCO—CH═CH₂; —OCO—C(CH₃)═CH₂; acetoacetoxy, —OCOCH═C(CH₃)(OH) and all suitable tautomer(s) thereof.

It will be appreciated that any suitable moieties represented by Formula 1′ could be used in the context of this invention such as other reactive moieties.

Unless the context clearly indicates otherwise, as used herein plural forms of the terms herein are to be construed as including the singular form and vice versa.

The term “comprising” as used herein will be understood to mean that the list following is non-exhaustive and may or may not include any other additional suitable items, for example one or more further feature(s), component(s), ingredient(s) and/or substituent(s) as appropriate.

The terms ‘effective’, ‘acceptable’ ‘active’ and/or ‘suitable’ (for example with reference to any process, use, method, application, preparation, product, material, formulation, compound, monomer, oligomer, polymer precursor, and/or polymers of the present invention and/or described herein as appropriate) will be understood to refer to those features of the invention which if used in the correct manner provide the required properties to that which they are added and/or incorporated to be of utility as described herein. Such utility may be direct for example where a material has the required properties for the aforementioned uses and/or indirect for example where a material has use as a synthetic intermediate and/or diagnostic tool in preparing other materials of direct utility. As used herein these terms also denote that a functional group is compatible with producing effective, acceptable, active and/or suitable end products.

Preferred utility of the present invention comprises imparting resistance to attack for example as described herein.

The terms ‘optional substituent’ and/or ‘optionally substituted’ as used herein (unless followed by a list of other substituents) signifies the one or more of following groups (or substitution by these groups): carboxy, sulpho, formyl, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulphonyl if directly attached to each other represent a sulphamoyl group). Preferred optional substituents comprise: carboxy, sulpho, hydroxy, amino, mercapto, cyano, methyl, halo, trihalomethyl and/or methoxy.

The synonymous terms ‘organic substituent’ and “organic group” as used herein (also abbreviated herein to “organo”) denote any univalent or multivalent moiety (optionally attached to one or more other moieties) which comprises one or more carbon atoms and optionally one or more other heteroatoms. Organic groups may comprise organoheteryl groups (also known as organoelement groups) which comprise univalent groups containing carbon, which are thus organic, but which have their free valence at an atom other than carbon (for example organothio groups). Organic groups may alternatively or additionally comprise organyl groups which comprise any organic substituent group, regardless of functional type, having one free valence at a carbon atom. Organic groups may also comprise heterocyclyl groups which comprise univalent groups formed by removing a hydrogen atom from any ring atom of a heterocyclic compound: (a cyclic compound having as ring members atoms of at least two different elements, in this case one being carbon). Preferably the non carbon atoms in an organic group may be selected from: hydrogen, halo, phosphorus, nitrogen, oxygen, silicon and/or sulphur, more preferably from hydrogen, nitrogen, oxygen, phosphorus and/or sulphur.

Most preferred organic groups comprise one or more of the following carbon containing moieties: alkyl, alkoxy, alkanoyl, carboxy, carbonyl, formyl and/or combinations thereof; optionally in combination with one or more of the following heteroatom containing moieties: oxy, thio, sulphinyl, sulphonyl, amino, imino, nitrilo and/or combinations thereof. Organic groups include all chemically possible combinations in the same moiety of a plurality (preferably two) of the aforementioned carbon containing and/or heteroatom moieties (e.g. alkoxy and carbonyl if directly attached to each other represent an alkoxycarbonyl group).

The term ‘hydrocarbo group’ as used herein is a sub-set of a organic group and denotes any univalent or multivalent moiety (optionally attached to one or more other moieties) which consists of one or more hydrogen atoms and one or more carbon atoms and may comprise one or more saturated, unsaturated and/or aromatic moieties. Hydrocarbo groups may comprise one or more of the following groups. Hydrocarbyl groups comprise univalent groups formed by removing a hydrogen atom from a hydrocarbon (for example alkyl). Hydrocarbylene groups comprise divalent groups formed by removing two hydrogen atoms from a hydrocarbon, the free valencies of which are not engaged in a double bond (for example alkylene). Hydrocarbylidene groups comprise divalent groups (which may be represented by “R₂C═”) formed by removing two hydrogen atoms from the same carbon atom of a hydrocarbon, the free valencies of which are engaged in a double bond (for example alkylidene). Hydrocarbylidyne groups comprise trivalent groups (which may be represented by “RC═”), formed by removing three hydrogen atoms from the same carbon atom of a hydrocarbon the free valencies of which are engaged in a triple bond (for example alkylidyne). Hydrocarbo groups may also comprise saturated carbon to carbon single bonds (e.g. in alkyl groups); unsaturated double and/or triple carbon to carbon bonds (e.g. in respectively alkenyl and alkynyl groups); aromatic groups (e.g. in aryl groups) and/or combinations thereof within the same moiety and where indicated may be substituted with other functional groups.

The term ‘alkyl’ or its equivalent (e.g. ‘alk’) as used herein may be readily replaced, where appropriate and unless the context clearly indicates otherwise, by terms encompassing any other hydrocarbo group such as those described herein (e.g. comprising double bonds, triple bonds, aromatic moieties (such as respectively alkenyl, alkynyl and/or aryl) and/or combinations thereof (e.g. aralkyl) as well as any multivalent hydrocarbo species linking two or more moieties (such as bivalent hydrocarbylene radicals e.g. alkylene).

As used in the chemical formulae and structures in the description and claims herein a dashed double line [symbol] indicates a carbon to carbon bond (or other bond as the context dictates) which may be a single or double bond.

Any radical group or moiety mentioned herein (e.g. as a substituent) may be a multivalent or a monovalent radical unless otherwise stated or the context clearly indicates otherwise (e.g. a bivalent hydrocarbylene moiety linking two other moieties). However where indicated herein such monovalent or multivalent groups may still also comprise optional substituents. A group which comprises a chain of three or more atoms signifies a group in which the chain wholly or in part may be linear, branched and/or form a ring (including spiro and/or fused rings). The total number of certain atoms is specified for certain substituents for example C_{1-N}organo, signifies a organo moiety comprising from 1 to N carbon atoms. In any of the formulae herein if one or more substituents are not indicated as attached to any particular atom in a moiety (e.g. on a particular position along a chain and/or ring) the substituent may replace any H and/or may be located at any available position on the moiety which is chemically suitable and/or effective.

Preferably any of the organo groups listed herein comprise from 1 to 36 carbon atoms, more preferably from 1 to 18. It is particularly preferred that the number of carbon atoms in an organo group is from 1 to 12, especially from 1 to 10 inclusive, for example from 1 to 4 carbon atoms.

As used herein chemical terms (other than IUAPC names for specifically identified compounds) which comprise features which are given in parentheses—such as (alkyl)acrylate, (meth)acrylate and/or (co)polymer—denote that that part in parentheses is optional as the context dictates, so for example the term (meth)acrylate denotes both methacrylate and acrylate.

The substituents on the repeating unit of a polymer and/or oligomer may be selected to improve the compatibility of the materials with the polymers and/or resins in which they may be formulated and/or incorporated for the uses described herein. Thus the size and length of the substituents may be selected to optimise the physical entanglement or interlocation with the resin or they may or may not comprise other reactive entities capable of chemically reacting and/or cross-linking with such other resins as appropriate.

Certain moieties, species, groups, repeat units, compounds, oligomers, polymers, materials, mixtures, compositions and/or formulations which comprise and/or are used in some or all of the invention as described herein may exist as one or more different forms such as any of those in the following non exhaustive list: stereoisomers (such as enantiomers (e.g. E and/or Z forms), diastereoisomers and/or geometric isomers); tautomers (e.g. keto and/or enol forms), conformers, salts, zwitterions, complexes (such as chelates, clathrates, crown compounds, cyptands/cryptades, inclusion compounds, intercalation compounds, interstitial compounds, ligand complexes, organometallic complexes, non-stoichiometric complexes, Tr-adducts, solvates and/or hydrates); isotopically substituted forms, polymeric configurations [such as homo or copolymers, random, graft and/or block polymers, linear and/or branched polymers (e.g. star and/or side branched), cross-linked and/or networked polymers, polymers obtainable from di and/or tri-valent repeat units, dendrimers, polymers of different tacticity (e.g. isotactic, syndiotactic or atactic polymers)]; polymorphs (such as interstitial forms, crystalline forms and/or amorphous forms), different phases, solid solutions; and/or combinations thereof and/or mixtures thereof where possible. The present invention comprises and/or uses all such forms which are effective as defined herein.

The layered materials may be swellable that is the distance between adjacent layers may be increased by any suitable means (for example by use of swelling agents which intercalate the material).

Advantageously one or more ingredients other than the polymer precursor may be added to the compositions of the invention to intercalate between the layers to increase the layer separation and reduce the attractive forces between the layers to the point that the individual layer structures can be more easily separated, for example using mechanical shear alone.

Preferably the layered mineral is allowed to swell for a period between half an hour and a few hours to aid break up of agglomerates within the mineral structure, although other well known methods to reduce agglomeration can be also used.

Further swelling agents may be added to compositions of the invention, the agent comprising any species capable of intercalating the layered mineral and thereby increasing the distance between the layers. However as the preferred polymers are small species of a low molecular weight (e.g. compared to the thermally cured matrix polymers and emulsion polymers used to prepare prior art thermally cured nanocomposites) additional swelling agent is not essential to incorporate these polymers in a nano-clay to form the radiation curable nanocomposites of the invention.

In a further aspect of the present invention there is provided a process for producing a radiation curable composition which comprises mixing a layered mineral with a radiation curable polymer precursor to form a radiation curable composition comprising the layered mineral.

A still further aspect of the present invention provides a process for producing a radiation curable composition which comprises
dispersing a layered mineral in an carrier medium to form a dispersion;
adding at least one swelling agent and/or a modifying agent;
subsequently adding a radiation curable polymer;
to form a radiation curable composition.

Optionally the composition may be cured by radiation whilst mixing under high shear to form in a single step a polymeric network in which the cured polymer is intercalated between the layered mineral, preferably the mineral is exfoliated.

Another aspect of the invention provides for any composition obtained and/or obtainable by a process of the invention.

A yet further aspect of the present invention provides a method for producing a coated article by coating an article with a radiation curable composition of the invention and thereafter initiating polymerisation of the composition by radiation to form a polymeric coat.

Preferably in the above processes, the composition of the invention comprises a polyol with a acrylic or methacrylic acid which may react (for example in the presence of the dispersion) under esterification conditions to form the radiation curable composition of the invention. The polymer precursors may comprise oligomers having free radical polymerisable double bounds are synthesised following well known processes. The polyols may be esterified with acrylic acid in presence of a acidic catalyst and wherein the water is removed by azeotropic distillation in presence of a solvent.

A yet other aspect of the invention provides for coated articles obtained and/or obtainable by the method of the invention and/or coated by any composition and/or coating of the invention.

Articles of the invention may be rigid, flexible and/or, elastomeric, and comprise for example free-standing films and membranes, which may be flexible and elastomeric, and may be coated as described herein.

In another process of the invention there is provide a method for preparing a radiation curable composition including a nanocomposite material comprising the steps of dispersing an organo modified layered mineral into oligomers having radiation polymerisable (preferably free radial polymerisable) double bonds to form a radiation curable composition including the nanocomposite material.

In compositions of the invention the mineral and the radiation curable resins may be dispersed in a random order with or preferably without use of a suitable diluent. If a solvent is used, it has been found that especially compositions based on diluents such as water, alcohols (ethanol), ethers, esters, ketones (acetone), and combinations thereof, benefit from the invention. It is preferred that the composition is free of organic solvents, more preferably comprises no more than 15% water, most preferably is free of any solvent.

The radiation curable resin may be mixed with or without the diluent and the modified filler, whereafter the whole composition is homogeneously mixed by means of known dispersion techniques, such as mechanical stirring, ultrasound vibration, dispersing, annealing etc.

Depending on the nature of the curing reaction, initiator, additives and pigments can be added to the composition. The initiator content is normally about 0.01 to 10% by weight with respect to the radiation curable resin, preferably between 0.1 and 5% of the to the radiation curable resin. The additive content can range between 0 and 15% by weight of the whole composition, preferably between 0 and 3%. The pigment content can range between 0 and 50% by weight, being preferably between 0 and 25%.

It is also possible to prepare a coating formulation completely, whereafter the modified filler is added. A homogeneous mixture is obtained according to techniques known to those skilled in the art, such as ultrasonically vibrating the whole for, for instance, 30 minutes.

In a still other process, the modified filler can be added at the start of synthesis, during the synthesis or during the work-up of the radiation curable resin. During the synthesis, a solvent can sometimes be used according to techniques known to those skilled in the art.

Thus epoxy (meth)acrylates, polyester (meth)acrylates, urethane (meth)acrylates, amino(meth)acrylates and/or (meth)acrylated monomers can be synthesised in the presence of nanoclays. Several advantages are combined in this process: the intercalation and/or exfoliation is promoted by the high temperature and shear (stirring) needed for the reaction, and surprisingly, the organoclays also accelerate the reaction rate. The nanoclay can thus act as catalyst. In a more preferred process, the onium cation is functionalised with carboxylic and/or hydroxyl groups that can react with the reagents used to prepare the radiation curable resin, and thus a covalent bond is formed between the onium salt and the oligomer. For example, a covalent bound can be formed by reaction of OH or COOH of the onium cation with isocyanate during the synthesis of urethane (meth)acrylates; a covalent bound can be formed by reaction of OH or COOH of the onium cation with epoxies during the synthesis of epoxy (meth)acrylates; a covalent bound can be formed by reaction of OH or COOH of the onium cation with polycarboxylic acids and/or polyols and/or (meth)acrylic acid during the synthesis of polyesteracrylates and/or (meth)acrylates monomers.

In another process, for example, the radiation curable composition including a nanocomposite material may be prepared by dispersing a layered mineral in water to form a dispersion, adding a swelling agent to the dispersion, and thereafter initiating the synthesis of the radiation curable resin.

For example, the esterification reaction of a polyol with acrylic or methacrylic acid may be achieved in the presence of the dispersion to form radiation curable composition including the nanocomposite material.

In the processes of the invention, the layered mineral may first be dispersed in a polar solvent by adding from about 0.01 to about 80 grams of mineral to 100 grams of polar solvent and preferably, about 0.1 to about 10.0 g of mineral to 100 g of polar solvent, and then vigorously mixing or shearing the mineral and polar solvent for a time sufficient to disperse the mineral in the polar solvent. Then a hydrocarbyl onium salt may be added to the dispersion, preferably as a solution in polar solvent, and with stirring.

The amount of the onium salt used in the process of the present invention depends on the type of layered material and the oligomer used as well as process conditions. In general, however, the amount of onium salt used will be in the range of the cation co-exchange capacity of the layered mineral to about 10% to about 2,000% of the cationic exchange capacity of the layered mineral.

Next, the radiation curable formulation is formed by adding to the mineral dispersion, the appropriate oligomer. Polymerisation inhibitors can be added to prevent unwanted polymerisation during this process. The blend is typically conducted at a temperature in the range of about 10° C. to about 100° C. and for a time sufficient to get intercalation or exfoliation of the layered clay.

The nanocomposite radiation curable composition described above can be used to form coatings or films following standard techniques employed for forming such materials.

In one embodiment of the present invention the nanocomposite radiation curable composition is dispersed with another radiation curable resin by blending and stirring. The amount of the nanocomposite radiation curable composition in the blend will be in the range of about 0.1 to about 70% by weight.

Further, it has been found that the modified filler substantially does not have any adverse effect on curing by radiation of the composition when it has been applied for forming a coating. Polymerisation by UV radiation or EB radiation proceeds with a energy comparable to the energy required for the neat radiation curable resin (without organoclays). The reactivity of the radiation curable resin remains thus substantially unaffected by the presence of the modified filler.

The composition can be used for applying coatings in any way. Suitable application procedures are, for instance, roller coater, curtain coater, spray, screen printing application and the like. After application, if a diluent is used, it is evaporated and a curing takes place by UV or EB radiation. The present composition is suitable for applying coatings to substrates of all kinds.

Examples of materials on which the substrate may be based comprise wood, metal, plastic, glass, textile, paper, cardboard, cable, optical fibres and the like.

The cured coating or film has particularly improved properties, such as improved flame retardancy, improved heat resistance, improved abrasion resistance, scratch resistance, barrier properties, outdoor resistance, mechanical properties and/or combination thereof.

Further features, embodiments, aspects and/or integers of the present invention are given in the claims.

The present invention is further illustrated by the non-limiting figure herein where:

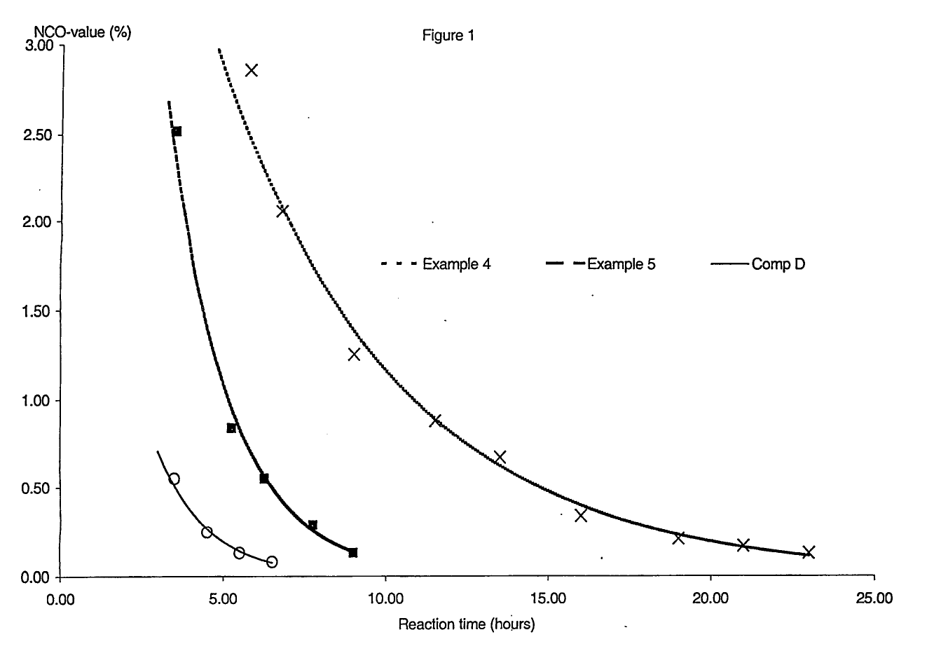

FIG. 1 is a plot of the NCO value of Examples 4 to 6 as a function of the reaction time in the second step of the standard method described to prepare these examples herein. A best fit curve has been drawn through each of the data sets plotted.

### EXAMPLES

The invention will presently be further exemplified by the following non-limiting examples.

Film coatings of the invention were prepared as described below from known UV curable hydroxy terminal acrylate oligomers (e.g. for Examples 1, 2 and Comp B that available from UCB Chemicals under the trade name Ebecryl 40) mixed with various montmorillonite nanoclays modified with various organo modifiers.

The clays used in the examples herein were:

The clay available commercially from Sud Chemie under the trade name Nanofil 804 comprising an ammonium cation bearing an aliphatic C₁₈ chain and two ethyl ethoxy groups, i.e. of formula:

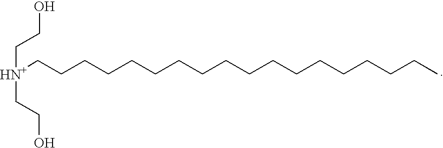

The clay available commercially from Sud Chemie under the trade name Nanofil 848 comprising an octadecylammonium cation of formula:

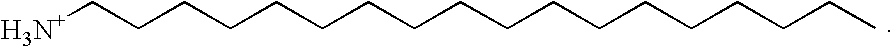

The bentonite clay available commercially from Southern Clay under the trade name Cloisite 30B comprising an organoammonium cation of formula: 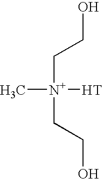
where HT denotes a hydrogenated tallow residue (˜65% C18; ˜30% C16; ˜5% C14)

The bentonite clay available commercially from Southern Clay under the trade name Closite 93 A which comprises a cation of formula. 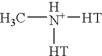
where HT is as given above.

Unless otherwise indicated the compositions herein (e.g. Examples 1 to 3 and Comp A to C) were each cured by electron beam, 5 MRad, 250 KeV, 20 m/min to give a coating of thickness 100 microns.

### Example 1

Clay (Nanofil 804) was weighed in glass vials to which UV curable hydroxy terminal acrylate oligomer (Ebecryl 40) was added as solvent to obtain a 5% dispersion of clay. A preliminary rough mixing was performed using a glass rod. Further mixing was achieved by subjecting the vials to ultrasound at room temperature and pressure (for 4 times over 15 secs each time). The vials were manually shaken between each cycle. The ageing of the sample led to a different amount of precipitated moiety. After settling, the sample was thermally annealed in oven at 60° C. for 1 hour leading to a 1 phase system. The composition was then applied as a layer to a substrate and cured to form a film

### Example 2

A Nanofil 804/Ebecryl 40 mixture (60 g) was prepared as Example 1 except the mixture was mechanically mixed at room temperature and pressure with a small diameter 4 blade propeller stirrer at a stirring speed of 1200 rpm for 85 min. Water was added stepwise in the amount of 30 microliters each time every 5 minutes, for a total volume of 450 microliters and total amount of 15% water in the composition. The composition was then applied as a layer to a substrate and cured to form a film.

Comp A and B

Comp A is the nanoclay (Nanofil 804) alone.

Comp B is a film coating prepared from pure Ebecryl 40 (without nanoclay).

When the XRD of films from Examples 1 and 2 were compared to the XRD pattern of Comp A this showed a general loss of the typical reflexes of the clay which indicates the presence of exfoliated clay and a certain percentage of clay as multi-layers intercalated by the polymer chains. The XRD also shows that making the dispersion more stable by adding water (Example 2) reveals no particular differences to the film with respect to the system without water (Example 1).

Thermogravimetric analysis (TGA) on nanocomposites can give insight on the role of the clay in perturbing the combustion profile. In fact, the contribution of the clay can lead to a macroscopic enhance of the charring phenomenon and to a shift of the loss in weight at higher temperatures. Example 1 and Example 2 were analysed with TGA using the conventional method with the following parameters: air purge, flow rate=10 ml/min, start temperature=35° C.; and temperature scan at 15° C./min up to 800° C. The results were displayed as a conventional TGA plot to give both weight % versus temperature and also the derivative of the weight % loss with respect to the time. Onset temperature for the decomposition was calculated from the TGA plots starting from the starting of the weight loss and the maximum of the decomposition rate. The temperature of minimum of the derivative (maximum rate of decomposition) was also calculated.

It was observed for both Examples 1 and 2 that the presence of the clay altered the decomposition profiles of the material compared Comp B (film of pure Ebecryl 40). While for the Example 1 the shift was not dramatic, for Example 2 (the system with water) the displacement towards higher temperatures was more evident. For Example 1 the onset of the transition was shifted about 6° C., as happens also for the decomposition rate maximum. For Example 2 the shift was about 23° C. for the onset and 16° C. for the rate maximum (all shifts relative to Comp B).

### Example 3

A further mixture was prepared analogous to Example 1 using a different clays and oligomers. The clay was Nanofil 848 and oligomer was hexanedioldiacrylate (HDDA). The mixture was mechanically mixed at room temperature and pressure with a small diameter 4 blade propeller stirrer at a stirring speed of 600 rpm for 1 hour.

The XRD pattern of the resultant film was compared with the XRD pattern from pure Nanofil 848 (Comp C) and this clearly showed that Example 3 had an exfoliated structure with total loss of crystallinity.

Thus the film coatings of the present invention comprising nanoclay and a UV cured polymer exhibit improved properties compared to films with either nanoclay or polymer alone.

The following examples (Examples 4 to 9) illustrate the synthesis approach to making the compositions of the invention.

### Example 4 to 6 and Comp D

Incorporation of Nanoclay at the Start of an Urethane Acrylate Synthesis—Catalyst Activity

To prepare each of the Examples 4 to 6 of the invention and a comparative example Comp D (without nanoclay) the following standard method was used.

To a 1 litre double jacket reactor vessel connected to an oil bath and equipped with a stirrer, was added ‘a’ g of isophoronediisocyanate (IPDI), ‘b’ g CAPA 200 (polycaprolactone from Solvay Interox®), ‘h’ g DBTL and ‘c’ g Cloisite 30 B (or Cloisite 93 A for Example 6, no nanoclay for comparative example Comp D). The reaction mixture was stirred and heated to 60° C. When the isocyanate content had reached a value of 6.72% (or 7.22% for Example 6), measured by a potentiometric titration according to ASTM D 2572-87, ‘d’ g of hydroxyethylacrylate (HEA), ‘e’ g hexanedioldiacrylate (HDDA), ‘f’ g hydroquinone (HQ) and ‘g’ g triphenylstibine (TFS) were added slowly to the reaction mixture at 60° C. when the isocyanate content was less than 0.15%. For Example 6, maturation was done at 80° C. The three systems (Examples 4 to 6) were homogeneous as no decantation was observed at room temperature over several days.

The values of the weights (in grams) ‘a’ to ‘h’ for the various ingredients used to prepare each of the Examples 4 to 6 and Comp D are given in Table 1 below

TABLE 1

| | | CAPA | | | | | | |
|---|---|---|---|---|---|---|---|---|
| | IPDI | 200 | Cloisite | HEA | HDDA | HQ | TFS | DBTL |
| Ex | ‘a’/g | ‘b’/g | ‘c’/g | ‘d’/g | ‘e’/g | ‘f’/g | ‘g’/g | ‘h’/g |
| 4 | 301.6 | 370 | 49 | 133.7 | 117 | 0.49 | 0.49 | 0 |
| | | | (Cloisite | | | | | |
| | | | 30 B) | | | | | |
| 5 | 301.6 | 370 | 49 | 133.7 | 117 | 0.49 | 0.49 | 0.24 |
| | | | (Cloisite | | | | | |
| | | | 30 B) | | | | | |
| 6 | 301.6 | 370 | 49 | 144.0 | 118 | 0.49 | 0.49 | 0.25 |
| | | | (Cloisite | | | | | |
| | | | 93 A) | | | | | |
| D | 301.6 | 370 | — | 133.7 | 117 | 0.49 | 0.49 | 0.24 |

The NCO values of the Examples 4 to 6 versus reaction time were measured in a conventional manner and the results plotted in FIG. 1.

Example 4 and 5 illustrate the catalytic activity of nanoclay Cloisite 30 B for the urethanisation reaction. No tin catalyst (DBTL, dibutyltindilaurate) was used in Example 4.

Examples 4 and 5 also illustrate the covalent approach. Without being bound by any mechanism the applicant believes that the OH groups of the ammonium cation of the nanoclay reacted with isocyanate (NCO decrease corresponded to the OH number of the onium cation in Cloisite 30 B). Examples 4, 5 and 6 also illustrate that nanoclay (Cloisite 30 B or Cloisite 93 A) can be added during synthesis of a urethane acrylate without any gelification (unwanted polymerisation) issues.

The following examples (Example 7 and 8) also illustrate the covalent approach and the catalyst activity of nanoclay for the synthesis of epoxy acrylates (reaction epoxide—acrylic acid).

### Example 7

Preparation of an Epoxyacrylate with 5 wt % Sud 804

In a double jacket reactor of 1.5 litres connected to an oil bad and equipped with a stirrer, were added 711.6 g of bisphenol A diglycidylether, 0.62 g of trisnonylphenylphosphite, 35.6 g Sud 804 and 6.0 g benzyltrimethylammoniumchloride. The reaction mixture was stirred and heated to 50° C. at atmospheric pressure and aged for 8 hours. After the ageing the mixture was heated to 110° C. 260.6 g acrylic acid, 0.42 g methyl ether hydroxyquinone and 10.1 g benzyltrimethyl ammonium chloride were fed in over 3 hours. After alimentation the mixture was stirred at 110° C. until the acid value was less than 5 mg KOH/g and the epoxy value was less than 0.5%. Then 0.59 g methyl ether hydroxyquinone, 0.76 g trisnonylphenylphosphite and 0.90 g oxalic acid was added.

### Example 8

A similar experiment was performed to that to prepare Example 7 above except the benzyltrimethyl ammonium chloride (catalyst) was omitted. Epoxy titration after addition of the nanoclay showed a slight decrease compatible with the reaction of the hydroxy groups of Nanofil 804 with the epoxide functions of the Epikote 828. After alimentation of acrylic acid, a strong epoxy and acid value was measured demonstrating the catalytic effect of the nanoclay.

### Examples 9 to 11

Coating Properties of Urethane Acrylate Formulations of the Invention

Various formulations of the invention (plus as a comparison Comp E without nanoclay) were prepared as shown in Table 2 and coated onto a conventional film substrate and then cured in situ to form a coat thereon.

TABLE 2

| | | | | Phase |
|---|---|---|---|---|
| | | | | separation |
| | | | | observed |
| | | | | after 7 days |
| Sample | Formulation | Nanoclay | Approach | at 80° C.? |
| Ex 9 | Ex 5 (80) + | Cloisite 30 B | Ex 5 synthesis | No |
| | HDDA (20) | | approach | |
| Ex 10 | Ex 6 (80) + | Cloisite 93 A | Ex 6 synthesis | yes |
| | HDDA (20) | | approach | |
| Ex 11 | (Comp D(95) + | Cloisite 30 B | Blend-no covalent | yes |
| | “Cloisite | | bond formed | |
| | 30B”(5)) (80) + | | | |
| | HDDA (20) | | | |
| Comp E | Comp D (80) + | None | Reference, | Not |
| | HDDA (20) | | example | applicable- |
| | | | without clay | |

Surprisingly, it was found that no phase separation was observed in Example 9 where the organo clay was introduced during the synthesis of the urethane acrylate (Example 5) and where the onium cation could react covalently with the oligomer (a covalent bond had been formed between the OH from the onium cation and the isocyanate).

The above formulations (Examples 9 to 11 and Comp E) were cured by electron beam (250 keV, 5 Mrad) and the cured films were evaluated following conventional methods such as described in “Test methods for UV & EB curable systems” (Dr. C. Lowe, Wiley/SITA Series in Surface Coatings Technology). The data obtained is given in Table 3.

TABLE 3

| Characteristic | Units | Ex 9 | Ex 10 | Ex 11 | Comp E |
|---|---|---|---|---|---|
| Surface tension | mN/m | 40.7 | 40.9 | 40.3 | 39.5 |
| Curl | g | 0.72 | 0.70 | 0.69 | 0.68 |
| Solvent resistance (10 μm) | ADR | >100 | 40-50 | 40-50 | 40-50 |
| Solvent resistance (20 μm) | ADR | >100 | >100 | >100 | >100 |
| Pendel hardness (90 μm) | Persoz in sec | 272 | 267 | 293 | 284 |
| Taber Haze (20 μm) | % haze (500 cycles) | 55.50 | 67.74 | 62.55 | 58.08 |
| Stain resistance (10 μm) | water | 0 | 0 | 0 | 0 |
| | coffee | 0 | 0 | 0 | 0 |
| | wine | 0 | 0 | 0 | 0 |
| | mustard | 0 | 0 | 0 | 0 |
| | ketchup | 0 | 0 | 0 | 0 |
| Adhesion on PET Melinex | | 100 | 100 | 100 | 100 |
| 813 (crosscut; %) | | | | | |
| Stability (80° C., 1 week) | — | OK | OK | OK | OK |

The data in Table 3 show that the solvent resistance of Example 9 is the best of the films tested. The other properties of Examples 9 to 11 are not negatively influenced by the presence of nanoclay as they are comparable to those of Comp E.

### Examples 12 to 14 and Comp F

Further UV curable formulations were made up as given in Table 4 by adding various photo-initiators to the previous formulations. Their UV reactivity was measured and the results are given in Table 5.

TABLE 4

| Sample | Formulation |
|---|---|
| Ex 12 | Ex 9 + 5% Irg 500 |
| Ex 13 | Ex 10 + 5% Irg 500 |
| Ex 14 | Ex 11 + 5% Irg 500 |
| Comp F | Comp E + 5% Irg 500 |

TABLE 5

| Characteristic | Units | Ex 12 | Ex 13 | Ex 14 | Comp F |
|---|---|---|---|---|---|
| Reactivity - talc dry | m/min | 1 × 10 | 1 × 10 | 1 × 10 | 1 × 10 |
| Reactivity - ADR | m/min | 1 × 5 | 1 × 5 | 1 × 5 | 1 × 5 |

Surprisingly, the applicant has shown that UV reactivity is not negatively influenced by the presence of nanoclay as the results of Example 12 to 14 are comparable to Comp F which does not contain nanoclay.

### Examples 15 to 17

Adhesion Improvement

A formulation without nanoclay (Comp G) was prepared by blending the following ingredients:

| Ingredient | Amount/g |
|---|---|
| EB 605/40 | 50 |
| tripropylene glycol diacrylate (TPGDA) | 17 |
| trimethylol propane triacrylate (TMPTA) | 15 |
| P115 | 8 |
| EB 350 | 0.5 |
| IRG 500 | 5 |
| EB 303 (55 parts)/HDDA (45 parts) | 10 |

where:
“EB 605/40” denotes the UV-curable acrylate oligomer available commercially from UCB Chemicals under the trade name Ebecryl 605/40.
“P115” denotes a liquid amine-functional acrylate additive available commercially from UCB Chemicals under the trade name Ebecryl P-115 which was added to increase cure speed.
“EB 350” denotes the silicone acrylate additive available commercially from UCB Chemicals under the trade name Ebecryl 350.
“IRG 500” denotes the photo-initiator available commercially from Ciba under the trade name “Irgacure 500”.
“EB 303” denotes a conventional additive available commercially from UCB Chemicals under the trade name “Ebecryl 303”.
HDDA denotes hexanedioldiacrylate (available commercially from UCB Chemicals)

Various amounts of nanoclay were then added to Comp G as shown in Table 6 and the different formulations were made up. They were applied conventionally at a coat weight of 3 to 4 g/m² to a 23 micron thick substrate of corona treated polyethylene (PE) or polyester (PET) film. The coating was cured with a UV curing Hg lamp; 160 W/cm, speed 25 m/min. The adhesion properties of the cured coats were tested in a conventional manner and the results are also given in Table 6.

TABLE 6

| | | | Adhesion | |
|---|---|---|---|---|
| | | (Brookfield | (cross-cut) | |
| Sample | Formulation | viscosity @ 25° C.) | PE | PET |

| | | | | |
|---|---|---|---|---|
| Comp G | See above | 320 mPas | 0 | 0 |
| Ex 15 | Comp G + 4 wt % | 320 mPas | 100% | 100% |
| | Nanofil 848 | | | |
| Ex 16 | Comp G + 4 wt % | 298 mPas | 100% | 100% |
| | Nanofil 804 | | | |
| Ex 17 | Comp G + 4 wt % | 370 mPas | 100% | 0% |
| | Cloisite 30 B | | | |

Surprisingly the data in Table 6 shows that adhesion of a conventional UV cured acrylate coating on polyethylene (PE) and/or polyester (PET) substrate is dramatically improved in the presence of organoclay.

1. A composite composition comprising a layered mineral and at least one polymer precursor which is substantially miscible therewith;
characterised in that:
(i) the polymer precursor is polymerisible by radiation to form a polymeric composition; and/or
(ii) the polymer precursor comprises a polymer obtained and/or obtainable by polymerisation with radiation.

2. A composite composition comprising a layered mineral such as nanoclay intercalated therein at least one polymer which is further polymerisable by radiation to form a polymeric network, such as a polymeric coating.

3. A composition as claimed in claim 1, in which the layered mineral is a natural or synthetic mineral selected from: kaolins, serpentines, talcs, pyrophyllites, ferropyrophyllites; smectites montmorillonites; illites micas glauconites calcdonia; chlorites vermiculites; palygorskites; sepiolites; mixed layer minerals which may comprise two three or more mineral components in random and/or regular order; amorphous clays, high alumina clays and/or any suitable mixtures and combinations thereof.

4. A composition as claimed in claim 1, in which the layered mineral selected from: smectite, montmorillonite, bentonite; beidellite, nontronite, hectrorite, fluorohectorite, saponite, sauconite; volkhonskoite, medmontite, pimelite, stevensite, stephanite; vermiculite, and/or halloysite.

5. A composition as claimed in claim 1, in which the polymer or polymer precursor is formed from oligomers having free radical polymerisable double bonds.

6. A composition as claimed in claim 1, in which the polymer or polymer precursor comprises (meth)acrylated oligomers.

7. A composition as claimed in claim 1, in which the layered mineral comprises nano-layers.

8. A composition as claimed in claim 1, which the layered mineral is exfolliated exfoliated.

9. A composition as claimed in claim 1, in which the layered mineral comprise from about 1% to about 15% by weight of the total composition.

10. A composition as claimed in claim 1, in which the counter cation comprises an activated unsaturated moiety represented by Formula 1′ which may be univalent if a substituent on a cation (such as an onium ion) and/or may bear a positive charge if comprising the whole cation, where Formula 1′ comprises: 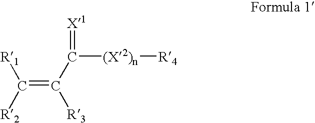
In which
n′ is 0 or 1,
X′¹ is oxy or, thio
X′² is oxy, thio or NR′₅ (where R′₅ represents H or optionally substituted organo),
R′₁, R′₂, R′₃ and R′₄ each independently represent H, optional substituents and/or optionally substituted organo groups; and
all suitable isomers thereof, combinations thereof on the same species and/or mixtures thereof.

11. A composition as claimed in claim 1, in which the counter cation is an optionally substituted onium ion.

12. A composition as claimed in claim 1, in which the counter cation is those represented by the formulae
⁺(MR¹R²R³R⁴); and/or ⁺(PyR⁴); where
M is nitrogen or phosphorus;
R¹, R², R³, and R⁴ independently denote hydrogen or an optionally substituted hydrocarbo group, preferably H or hydrocarbyl optionally substituted by one or more hydroxy or carboxy group(s), more preferably H or alkyl, aryl or allyl group, most preferably at least one of which is other than hydrogen and is substituted by a hydroxy or carboxy group; and
Py denotes a pyridinium or an alkyl substituted pyridinium group.

13. A composition as claimed in claim 1, in which the counter cation is represented by one or more of the following formulae 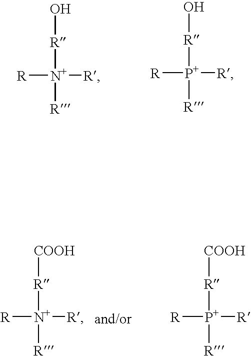
in which R, R′ and R″ independently represent H or any suitable optionally substituted organo group such as optionally substituted C₁₋₃₀hydrocarbyl, for example C₁₋₂₀alkyl; and R′″ independently represents any suitable optionally substituted divalent organo linking group such as optionally substituted C₁₋₃₀hydrocarbylene, for example C₁₋₂₀alkylene, and where optionally the OH or COOH in these formulae may be replaced by any one of the moieties described in claim 15.

14. A composition as claimed in claim 1, in which the counter cation is selected from the group consisting of: 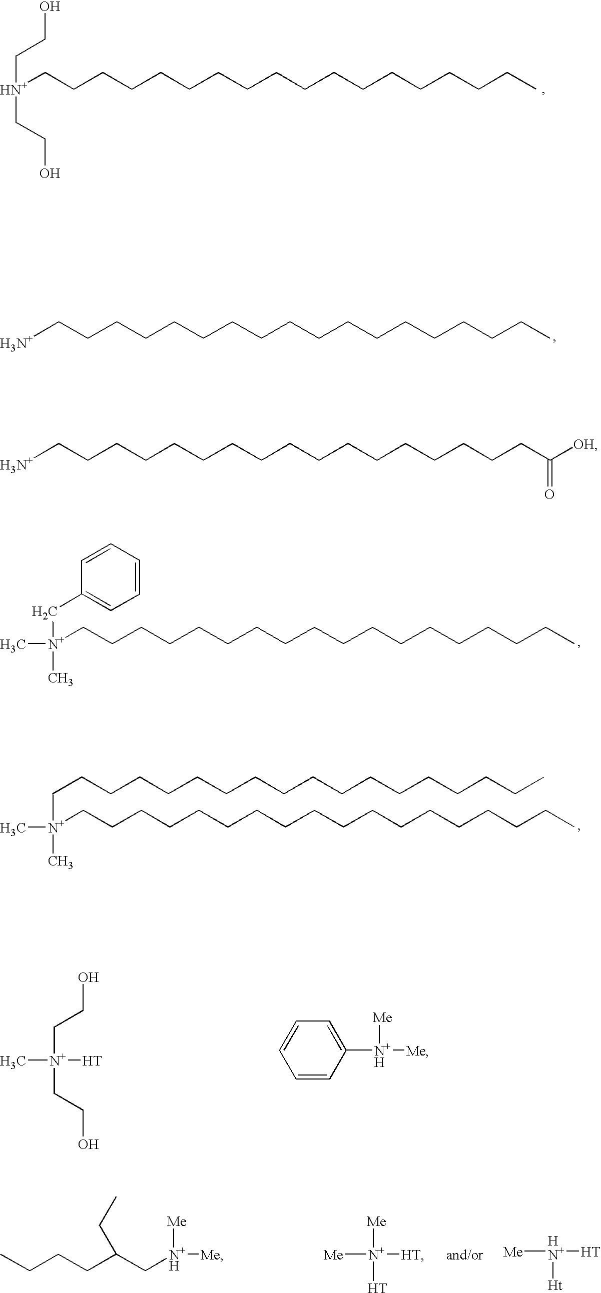
where HT denotes a hydrogenated tallow residue comprising the following mixture of linear alkyl groups in the proportions about 65% C₁₈alkyl, about 30% C₁₆alkyl and about 5% C₁₄alkyl.

15. A composition as claimed in claim 1, in which the counter cation comprises at least one moiety, which may comprises an optional substituent on the cation and/or replace any hydroxy and/or carboxy thereon, the moiety selected from group consisting of: 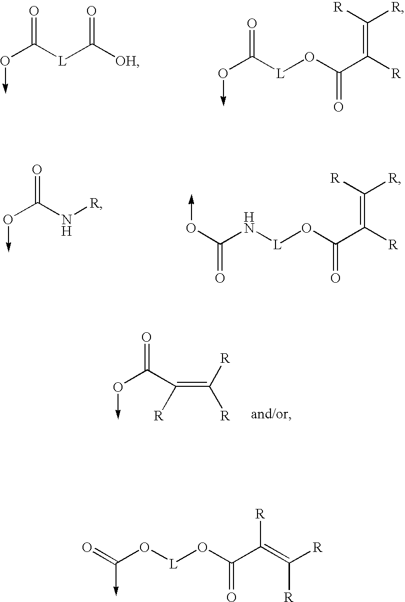
where L independently denotes any suitable divalent organic linking group and R independently denotes in each instance within each moiety any suitable optionally substituted hydrocarbo group.

16. A composition as claimed in claim 1, in which the counter cation comprises at least one moiety, which may comprises an optional substituent on the cation and/or replace any hydroxy and/or carboxy thereon, the moiety selected from group consisting of: 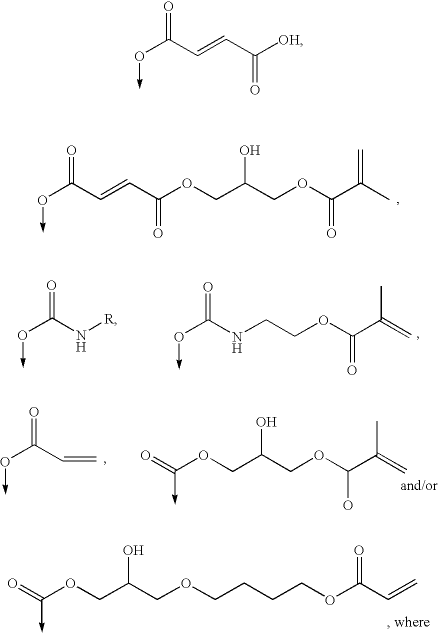
the arrow denotes a covalent bond with the remaining counter cation,
a dashed double line [symbol] indicates a carbon to carbon bond which may be a single or double bond; and/or
any of these moieties may be further optionally substituted.

17. A composition as claimed in claim 1, in which the counter cation can be further modified to be polymerisable by radiation.

18. A process for preparing a nanoclay as claimed in claim 1 comprising the step of:
(a) replacing cations in a nanoclay with an onium ion functionalised with at least one hydroxy group,
(b) reacting the onium ion with an (optionally substituted) reagent selected from:
(i) maleic or succinic anhydride 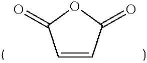
followed by an (poly)oxirane e.g. glycidyl methacrylate 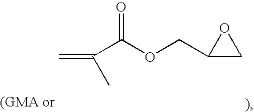
(ii) (poly)isocyanate (such as those comprising at least one R—NCO); optionally in the absence of additional catalyst for urethanisation (e.g. omit dibutyltindilaurate (DBTL));
(iii) methacrylate isocyanate 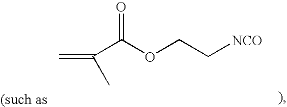
optionally in the absence of additional catalyst for urethanisation (e.g. omit dibutyltindilaurate (DBTL));
(iv) (meth)acrylate 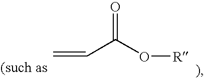
where it is preferred that R′ is H or alkyl;
(v) a (poly)oxirane
(vi) a polycarboxylic acid

19. A process for preparing a nanoclay as claimed in claim 18 comprising the step of
(a) replacing cations in a nanoclay with an onium ion functionalised with at least one carboxy group
(b) reacting the onium ion with an optionally substituted cyclo(alkoxy) (meth)acrylate
(c) reacting the onium salt with an (poly)oxirane
(d) reacting the onium salt with a polyol

20. A process as claimed in claim 19 in which the cyclo(alkoxy) (meth)acrylate is of formulae 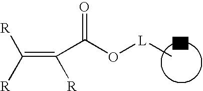
where L independently denotes any suitable divalent organic linking group and R independently denotes in each instance any suitable optionally substituted hydrocarbo group.

21. A process as claimed in claim 20 in which the cyclo(alkoxy)(meth) acrylate is an oxirane (alkyl)(meth)acrylate.

22. A process as claimed in claim 21 in which the oxirane (alkyl)(meth)acrylate is an epoxy (meth)acrylate such as either glycidyl methacrylate

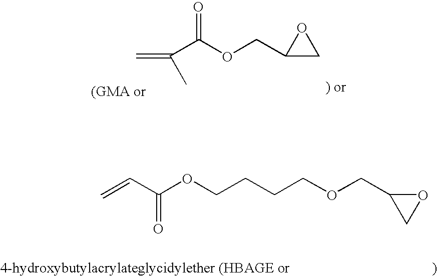

23. A process for preparing a nanoclay as claimed in claim 18 comprising the steps of
(a) protonating and/or alkylating an amino functional radiation polymerisable oligomer by radiation to form a cation thereof
(b) ion exchanging the oligomer cation with a cation from a nanoclay to form a clay intercalated with cationic oligomer as counter ion.

24. A process as claimed in claim 23, where the oligomer is an amino (meth)acrylate.

25. A process as claimed in claim 18 which comprises further step of exfoliating the clay.

26. A process as claimed in claim 18 in which the steps are carried out in a single container without intermediate isolation or purification steps.

27. A process as claimed in claim 23 which comprises further step of exfoliating the clay.

28. A nanoclay obtained and/or obtainable by a process as claimed in claim 18 in which the mineral layers are intercalated with polymer.

29. A nanoclay as claimed in claim 28 in which the mineral layers are substantially completely exfoliated.

30. A nanoclay, mineral, coating and/or composition as claimed in claim 28 which is substantially free of tin catalyst.

31. A substrate coated with a film comprising a composition as claimed claim 1.
